(19) United States
(12) Patent Application Publication
(10) Pub. No.: US 2024/0158314 A1
(43) Pub. Date: May 16, 2024

(54) SCENTED SOIL ADDITIVE IN DISSOLVING COMPOSITION

(71) Applicant: Andrew Graff, Laguna Beach, CA (US)

(72) Inventor: Andrew Graff, Laguna Beach, CA (US)

(21) Appl. No.: 18/505,717

(22) Filed: Nov. 9, 2023

Related U.S. Application Data
(60) Provisional application No. 63/424,206, filed on Nov. 10, 2022.

(51) Int. Cl. C05F 3/02; C05F 1/00; C05F 11/00

(52) U.S. Cl. CPC C05F 3/02; C05F 1/005; C05F 1/007; C05F 11/00

(57) ABSTRACT

A composition of matter comprising a plant-usable nutrient derived from a first source, an odiferous compound obtained from a second source different from the first source; and a water-dissolvable carrier that carries the plant-usable nutrient and the odiferous compound.

This application claims the benefit and priority of U.S. Provisional Patent Application No. 63/424,206, filed on Nov. 10 2022, which is incorporated herein by reference in its entirety.

### FIELD OF THE INVENTION

The field of the invention is plant fertilizers.

### BACKGROUND

The background description includes information that may be useful in understanding the present invention. It is not an admission that any of the information provided herein is prior art or relevant to the presently claimed invention, or that any publication specifically or implicitly referenced is prior art.

Plant fertilizers, especially those from natural sources such as guano, large animal dung or other animal wastes can have an undesirable odor. The odor can be especially problematic when used on indoor plants.

GrowScripts™ markets a leaf spray advertised as combining a plant supplement with a desirable smelling odorant. See http://www.growscripts.com/burst-scented-plant-food-nutrition/#. However, such leaf sprays would necessarily be short-acting, and would likely deliver only small amounts of nitrogen, phosphorus, or other plant nutrients to the soil.

The GrowScripts reference, and all other publications discussed herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

What is still needed is a water-dissolvable carrier that can be inserted into the soil, that would provide both significant amounts of plant nutrients, as well as contributing a desirable odor to the environment.

The following description includes information that may be useful in understanding the present invention. It is not an admission that any of the information provided herein is prior art or relevant to the presently claimed invention, or that any publication specifically or implicitly referenced is prior art.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides apparatus, systems and methods in which a water-dissolvable carrier is used to distribute a plant-usable nutrient derived from a first source, and an odiferous compound obtained from a second source different from the first source.

The first source can advantageously be selected from the group comprising an animal excrement, an animal shell, a ground shell of a plant, and seaweed. For example, the source of the plant-usable nutrient can be guano, egg shell, coffee grounds, or seaweed.

The odiferous compound preferably comprises an essential oil of a culinary herb, for example thyme, clove, rosemary, lavender, yarrow, basil, and peppermint.

The carrier can have any suitable shape, including for example, a stick, bead or tablet. Contemplated carriers include one or more water-dissolvable polymers, for example, poly (hydroxypropyl methacrylate), poly (l-lysine), poly (aspartic acid), poly (vinylpyrrolidone), poly (N-vinyl-2-pyrrolidone-co-vinylamide), and poly (styrene co-maleic acid/anhydride). Especially preferred water-dissolvable polymers include hydrolyzed collagen and dissolvable seaweed powder.

Carriers can advantageously comprise a compressed multi-component powder.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic showing production of fragrance-loaded alginate beads made with alginate-chitosan blend, with and without Ca++ crosslinking, using Tween 40 or Tween 20 as emulsifier.

FIG. 2 is a schematic showing production of fragrance-loaded alginate beads made with alginate-chitosan blend, with and without Ca++ crosslinking, using capsul chemically modified food starch as emulsifier.

FIG. 3 is a schematic showing production of fragrance-loaded alginate beads made with alginate-chitosan blend, with and without Tripolyphosphate crosslinking, using Tween 40 or Tween 20 as emulsifier.

FIG. 4 is a schematic showing production of fragrance-loaded alginate beads made with alginate-chitosan blend, with and without Tripolyphosphate crosslinking, using capsul chemically modified food starch as emulsifier.

FIG. 5 is a diagram of an experimental setup to encapsulate oil in Ca-alginate capsules.

FIG. 6 is a collection of two tables depicting properties of samples according to inventive concepts herein.

FIG. 7 is a schematic showing production of essential oil-loaded alginate beads.

FIG. 8 is a schematic showing production of essential oil-loaded alginate beads and coat/mix with chitosan and dry, post-crosslinked with Ca++ or Tripolyphosphate.

FIG. 9 is a schematic showing production of essential oil-loaded alginate beads and coat/mix with protein (i.e. pea protein) and dry.

FIG. 10 is a schematic showing production of essential oil emulsion, stabilized by food starch and sodium alginate, optionally post-crosslinked with Ca++ or Tripolyphosphate.

FIG. 11 is a schematic showing production of essential oil-loaded alginate beads and coat/mix with protein (i.e. pea protein) and dry, post-crosslinked with Ca++ or Tripolyphosphate.

FIG. 12 is a schematic showing a process for deacetylation conversion of chitin to chitosan.

FIG. 13 is a schematic showing a process for encapsulation by complex coacervation.

FIG. 14 is a schematic showing a process for encapsulation using starch spray-drying.

FIG. 15 is a schematic showing a process for moisture-activated release from starch spray-dried powder.

FIG. 16 is a schematic showing contemplated interaction of sodium alginate with calcium ions.

FIG. 17 is a schematic representation of an ionic gelation and polyelectrolyte complexation method.

FIG. 18 is a schematic illustration of strategies for encapsulating hydrophilic compounds with (a) traditional hydrogel beads and (b) microcapsules prepared with water/oil emulsion via ultrasonication.

FIG. 19 is a flowchart of a contemplated process and formulation for encapsulating trans-cinnamaldehyde.

FIG. 20 is a flowchart showing selection of a preferred chitosan-alginate mass ratio.

FIG. 21 is a graph with visual representations of effects of chitosan and alginate concentration on physical stability and appearance of nanoparticle solutions.

FIG. 22 is a collection of two tables depicting Observational results of varying mass ratios of alginate to chitosan.

### DETAILED DESCRIPTION

Preferred embodiments include fertilizers that break down and release a pleasant scent when watered. The scents can have dual purposes, such as a feline and bug repellant. It is contemplated that some consumers don't have house plants because their felines tend to play with and/or destroy their house plants, and products as discussed herein could help with that situation. In short, contemplated products can offer consumers a simple pleasure of a nice smell filling one's living space, without requiring a flame as would be necessitated by a burning candle.

Contemplated substances that can be used to provide the desirable odors in essential oils of thyme, clove, rosemary, lavender, yarrow, basil oil, and peppermint, or other culinary herbs. These substances are also considered advantageous for the plants. Using essential oils helps in the prevention of animals and pests, while encouraging plants' growth.

Contemplated form factors for the carriers include beads, sticks, funnels, and powders. Sticks can have different sizes depending on the plant/planter sizes. A bio-degradable funnel could contain beads or other bulk nutrients. funnel. The funnel spike' can advantageously break down when poured over with water. The beads can go into the funnel spike to release the smell. Once the spike dissolves, a consumer could buy and install a new spike'.

Three tiers of desirable smells can be characterized as follows:
1) Affordable “clean” smell. This could be used for hotels/malls/nursing homes.
2) “Sophisticated”—for example “Santal 33™”
3) Neutral or minimal scent. Just to clean the space/pet/pest repellent.

The base of the product could be polyphosphate beads infused with the other ingredients and oils. Another option would be calcium condensed and infused with the ingredients/oils. As the water interacts with the calcium, I think this could disperse the smell further.

Egg shells and coffee grounds could be obtained from local restaurants as a way to boast their “eco friendly” goals.

Seaweed is a broad spectrum fertilizer that is rich in beneficial trace minerals and hormones that stimulate plant growth. Seaweed is high in carbohydrates which are essential building blocks in growing plants, and low in cellulose so it breaks down readily.

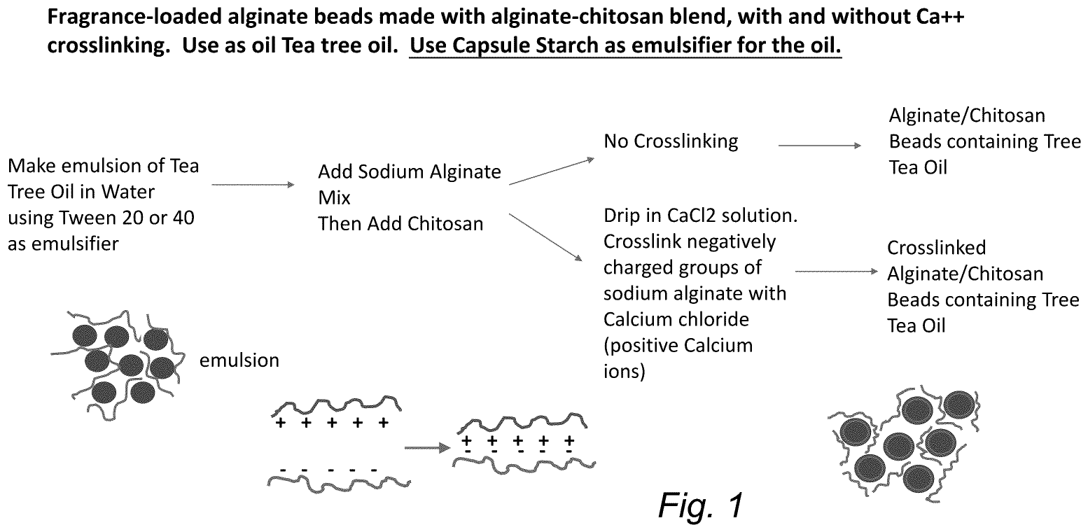

Experimentation was performed to produce samples of the claimed substances. Various methods and results are shown in FIGS. 1-22, as described below.

FIG. 1 is a schematic showing production of fragrance-loaded alginate beads made with alginate-chitosan blend, with and without Ca++ crosslinking, using Tween 40 or Tween 20 as emulsifier.

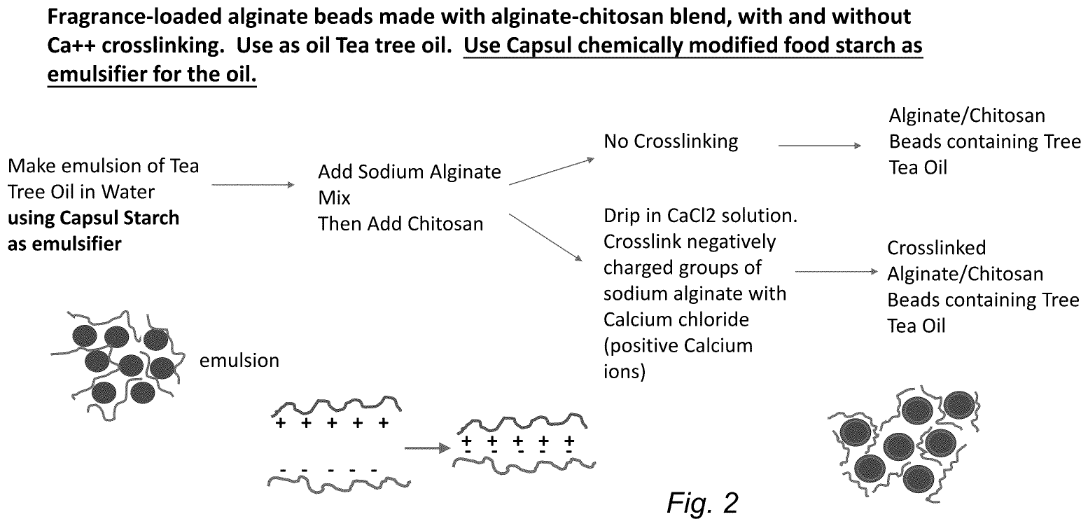

FIG. 2 is a schematic showing production of fragrance-loaded alginate beads made with alginate-chitosan blend, with and without Ca++ crosslinking, using capsul chemically modified food starch as emulsifier.

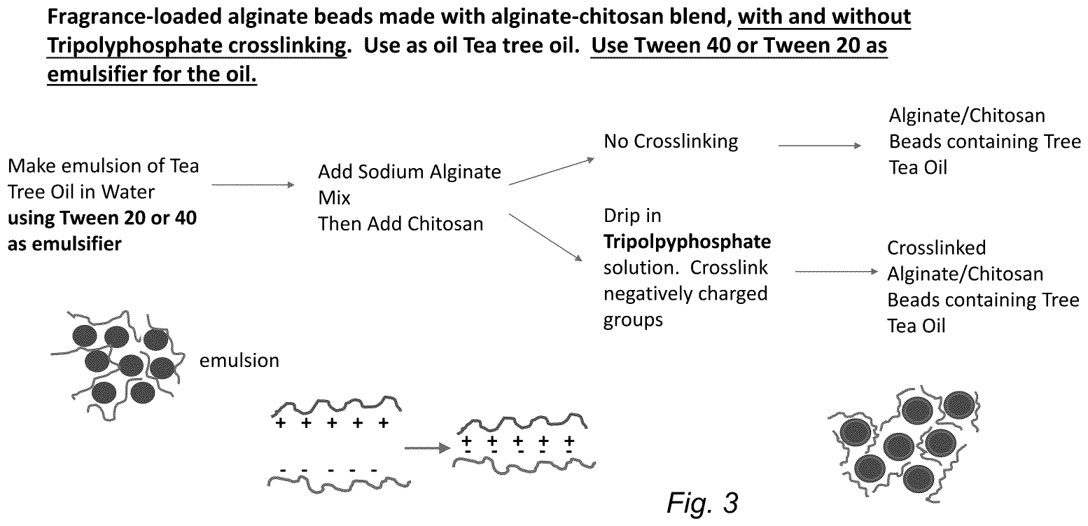

FIG. 3 is a schematic showing production of fragrance-loaded alginate beads made with alginate-chitosan blend, with and without Tripolyphosphate crosslinking, using Tween 40 or Tween 20 as emulsifier.

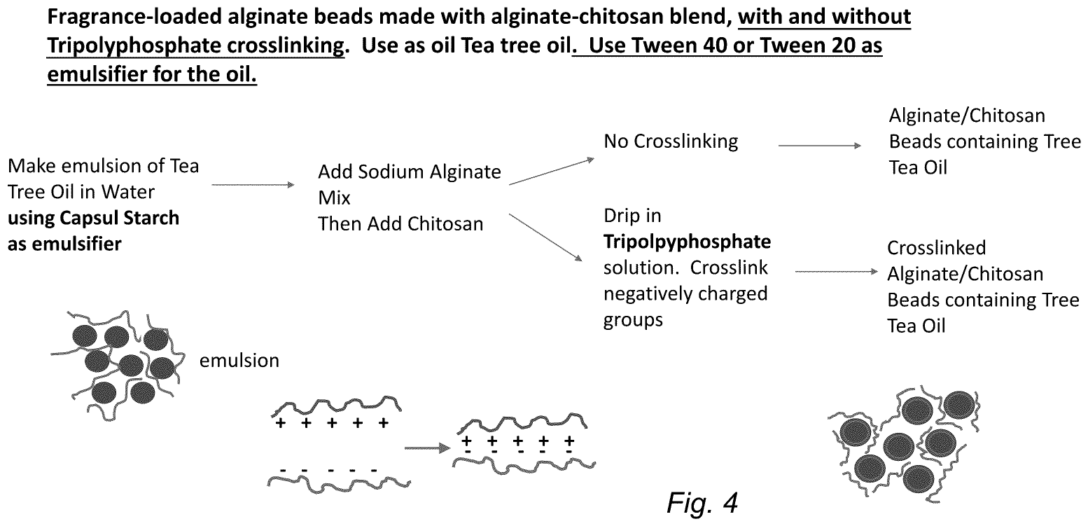

FIG. 4 is a schematic showing production of fragrance-loaded alginate beads made with alginate-chitosan blend, with and without Tripolyphosphate crosslinking, using capsul chemically modified food starch as emulsifier.

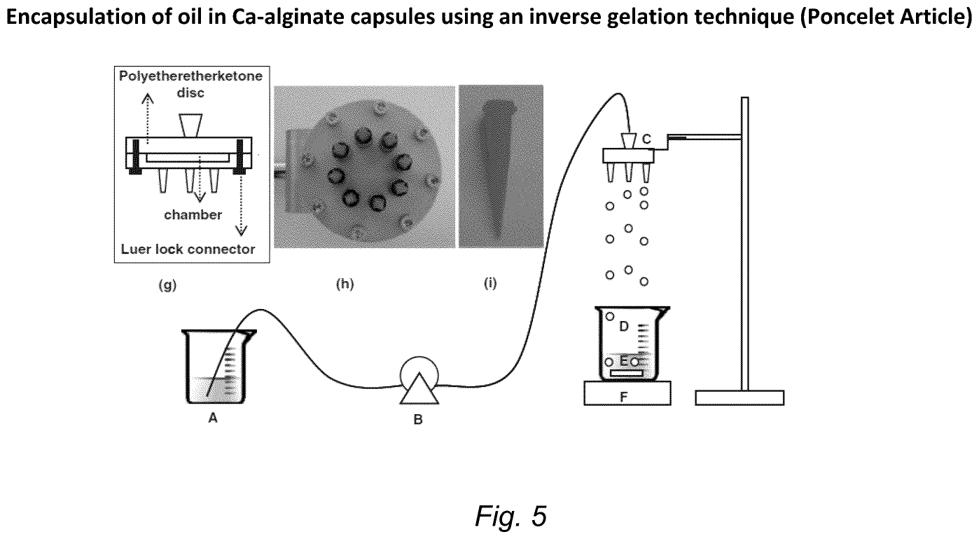

FIG. 5 is a diagram of an experimental setup to encapsulate oil in Ca-alginate capsules.

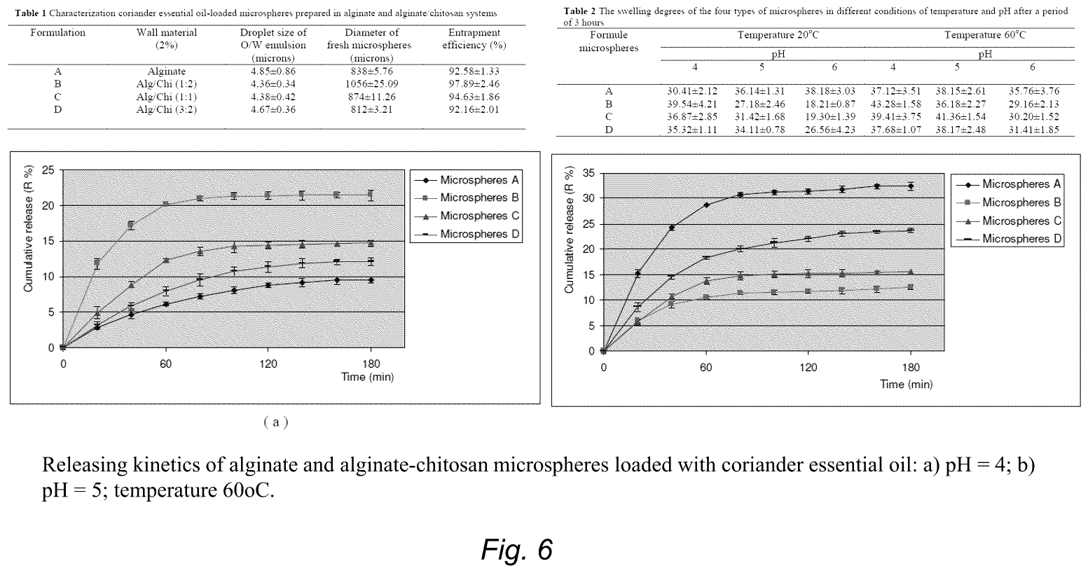

FIG. 6 is a collection of two tables depicting properties of samples according to inventive concepts herein.

Contemplated non-layered options include the following:
1. Fragrance-loaded alginate beads made with alginate-chitosan blend, with and without Ca++ crosslinking. Use as oil Tea tree oil. Use Tween 40 or Tween 20 as emulsifier for the oil.
2. Fragrance-loaded alginate beads made with alginate-chitosan blend, with and without Ca++ crosslinking. Use as oil Tea tree oil. Use Capsul chemically modified food starch as emulsifier for the oil.
3. Fragrance-loaded alginate beads made with alginate-chitosan blend, with and without Tripolyphosphate crosslinking. Use as oil Tea tree oil. Use Tween 40 or Tween 20 as emulsifier for the oil.
4. Fragrance-loaded alginate beads made with alginate-chitosan blend, with and without Tripolyphosphate crosslinking. Use as oil Tea tree oil. Use Capsul chemically modified food starch as emulsifier for the oil.
5. In 3, 4, 5, and 6 vary degree of crosslinking to create the desired release profile (perhaps initially explored by swelling of a cast film)
6. Encapsulation of oil in Ca-alginate capsules using an inverse gelation technique

Contemplated layer options include the following:
1. Essential oil-loaded alginate beads and coat/mix with chitosan and dry
2. Essential oil-loaded alginate beads and coat/mix with chitosan and dry, post-crosslinked with Ca++ or Tripolyphosphate
3. Essential oil-loaded alginate beads and coat/mix with protein (i.e. pea protein) and dry
4. Essential oil-loaded alginate beads and coat/mix with protein (i.e. pea protein) and dry, post-crosslinked with Ca++ or Tripolyphosphate
5. Essential oil emulsion, stabilized by food starch and sodium alginate, form beads and then mix with chitosan or protein (i.e. pea protein), optionally post-crosslinked with Ca++ or Tripolyphosphate
6. Initial film exploration: Explore layered films and their release/swelling profile. Initial test: in petrie dish, place solution of alginate and chitosan with various levels of Ca++, let dry and then study dissolving/swelling in water. See article “pH responsive chitosan alginate polyelec.pdf”.

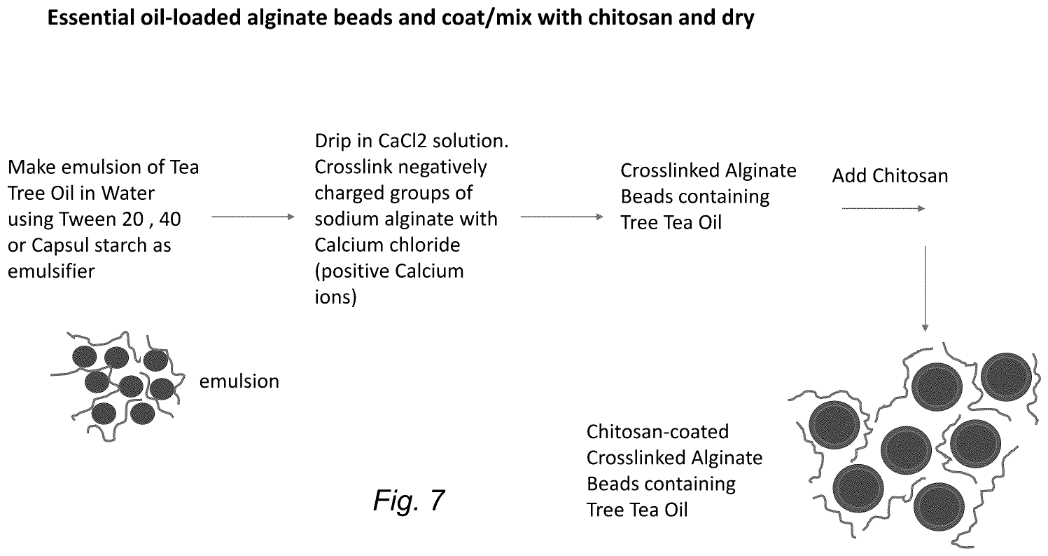

FIG. 7 is a schematic showing production of essential oil-loaded alginate beads.

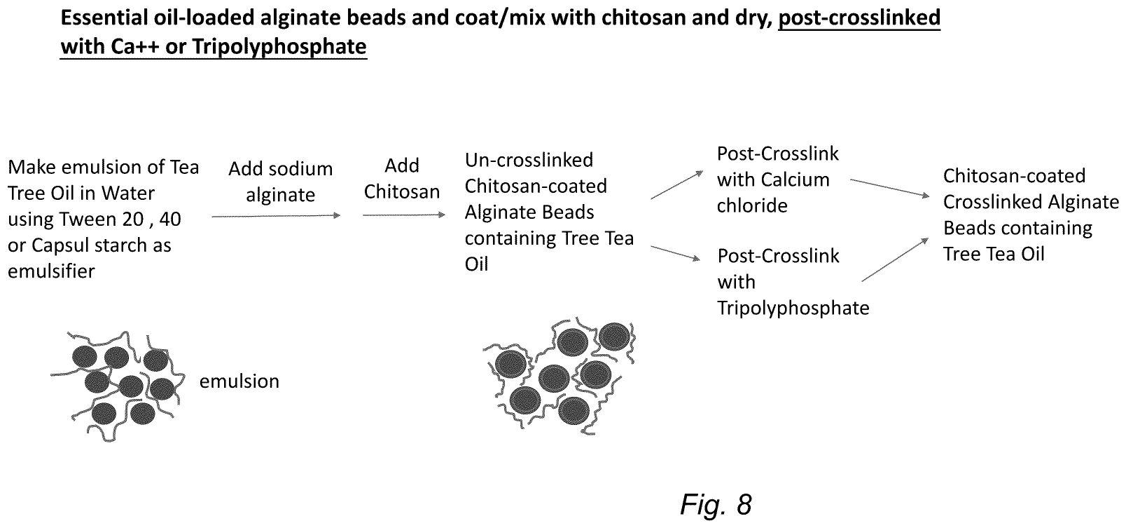

FIG. 8 is a schematic showing production of essential oil-loaded alginate beads and coat/mix with chitosan and dry, post-crosslinked with Ca++ or Tripolyphosphate.

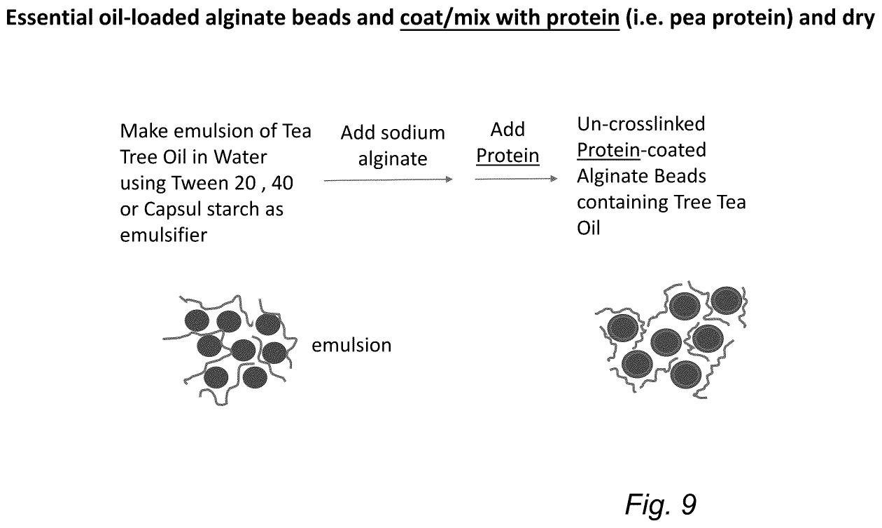

FIG. 9 is a schematic showing production of essential oil-loaded alginate beads and coat/mix with protein (i.e. pea protein) and dry.

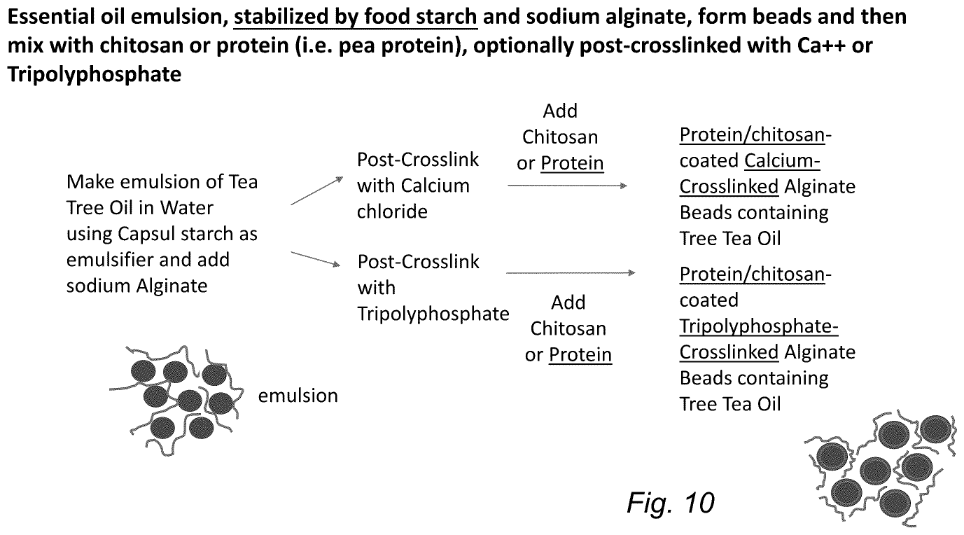

FIG. 10 is a schematic showing production of essential oil emulsion, stabilized by food starch and sodium alginate, optionally post-crosslinked with Ca++ or Tripolyphosphate.

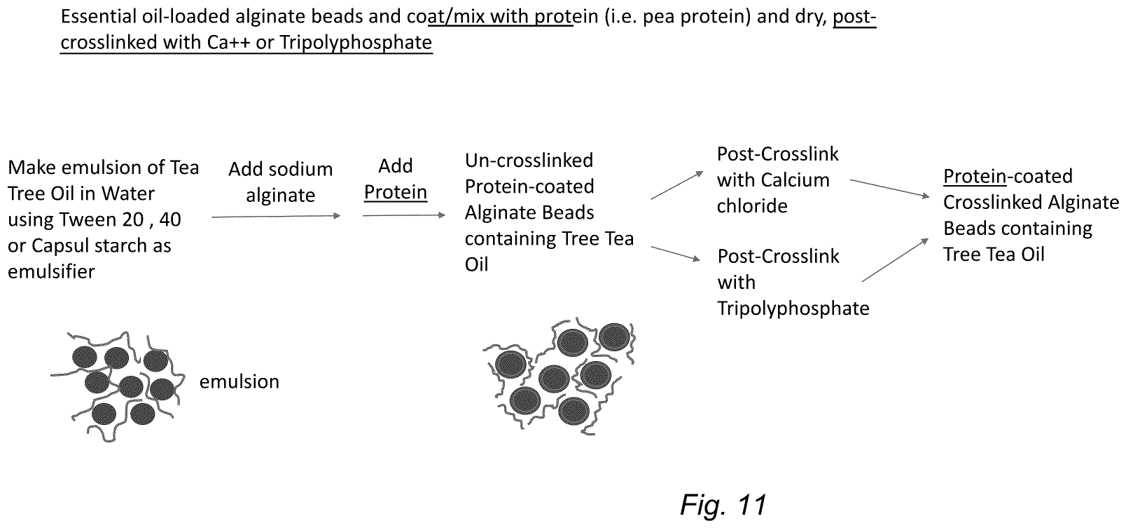

FIG. 11 is a schematic showing production of essential oil-loaded alginate beads and coat/mix with protein (i.e. pea protein) and dry, post-crosslinked with Ca++ or Tripolyphosphate.

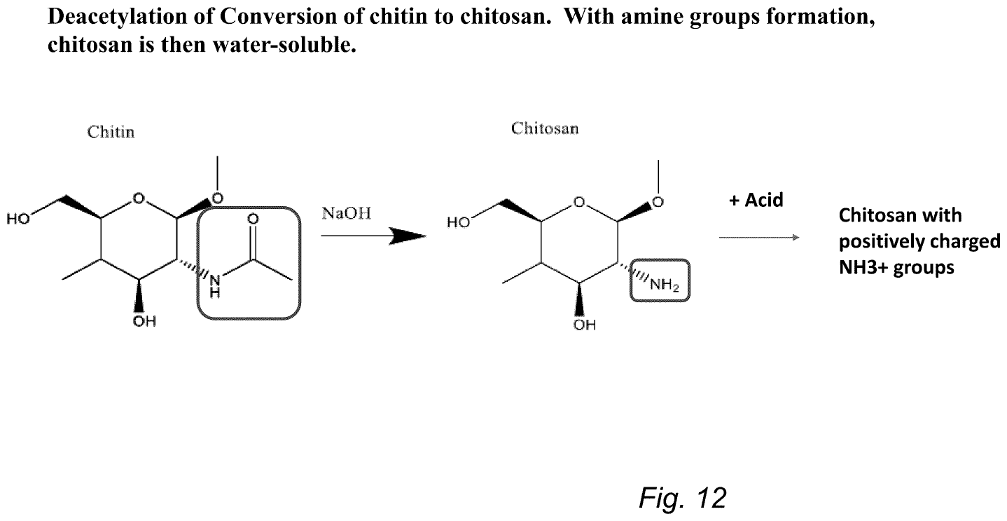

FIG. 12 is a schematic showing a process for deacetylation conversion of chitin to chitosan.

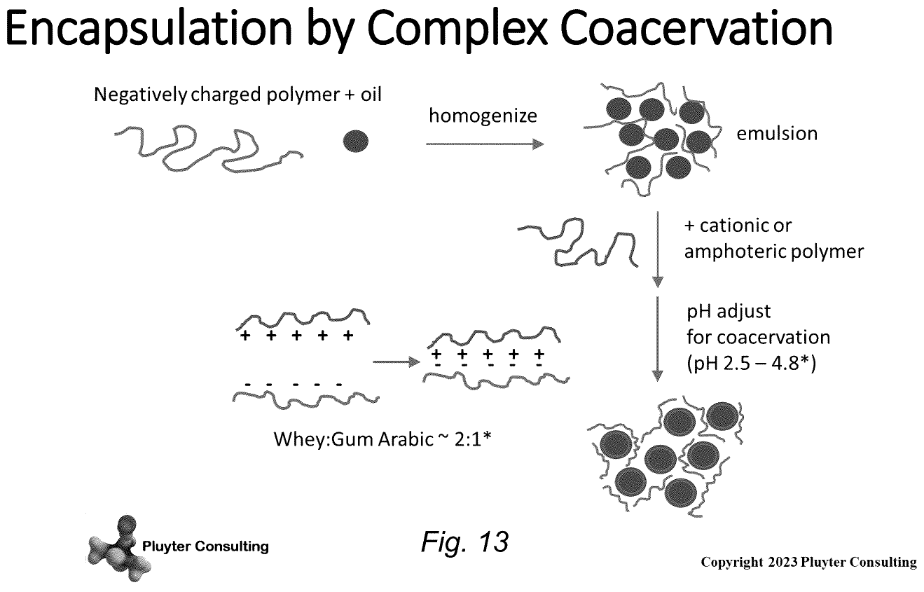

FIG. 13 is a schematic showing a process for encapsulation by complex coacervation.

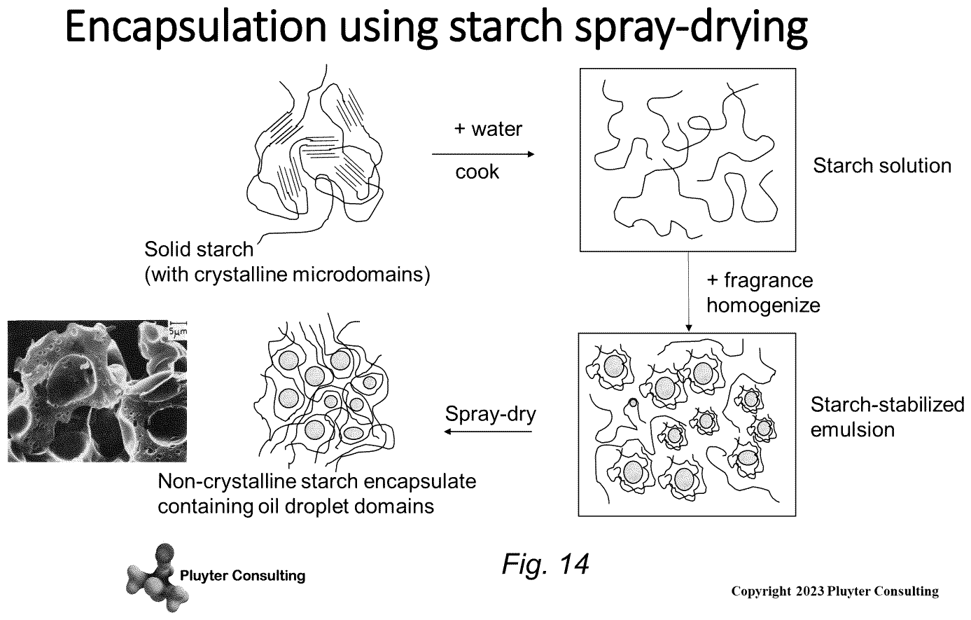

FIG. 14 is a schematic showing a process for encapsulation using starch spray-drying.

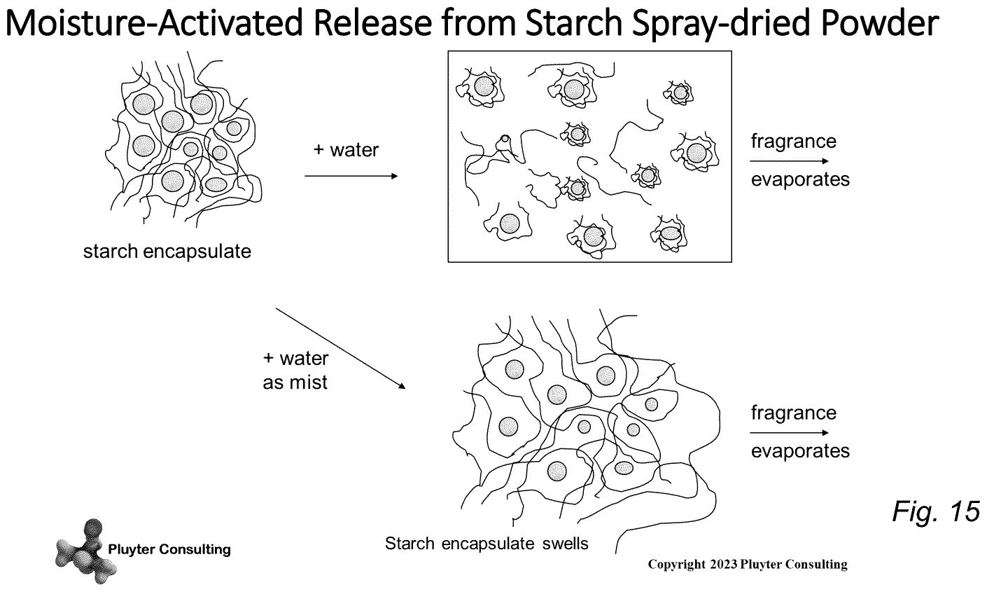

FIG. 15 is a schematic showing a process for moisture-activated release from starch spray-dried powder.

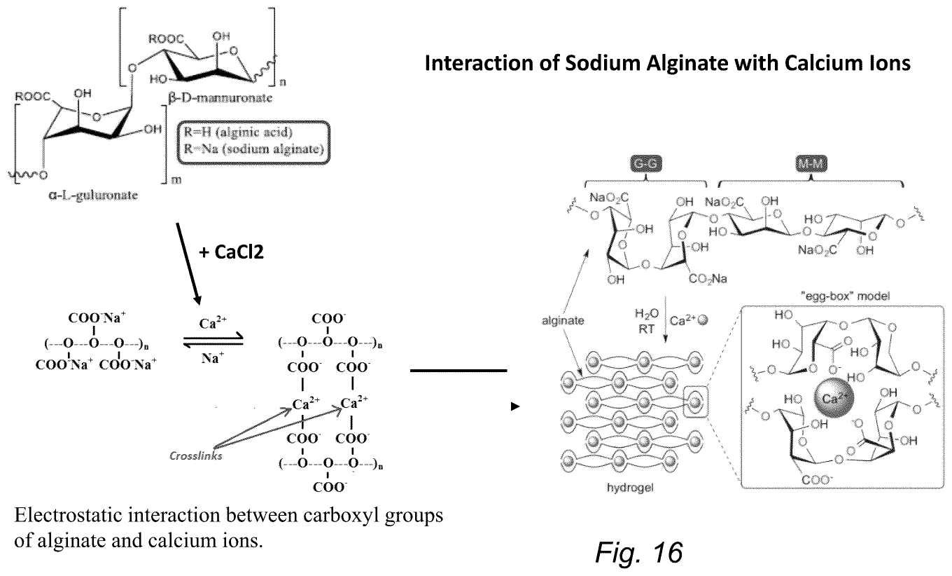

FIG. 16 is a schematic showing contemplated interaction of sodium alginate with calcium ions.

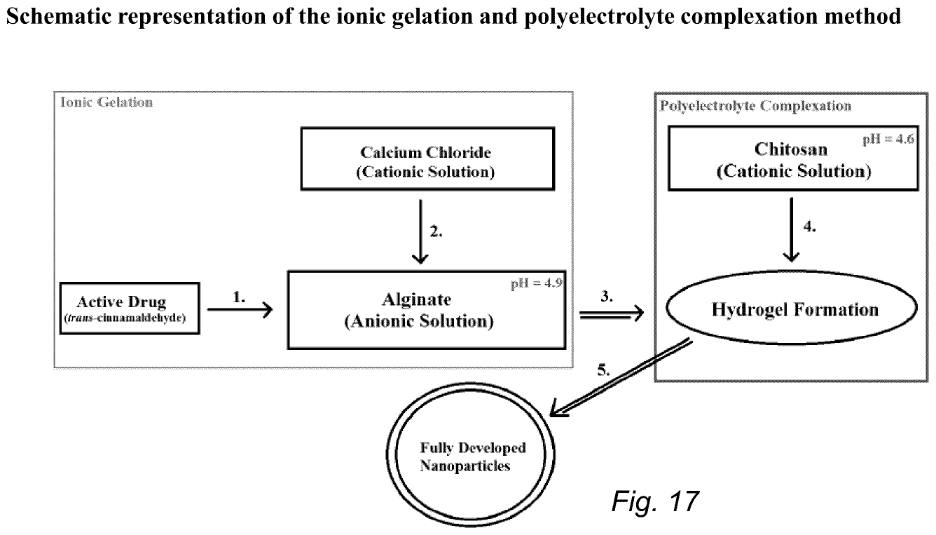

FIG. 17 is a schematic representation of an ionic gelation and polyelectrolyte complexation method.

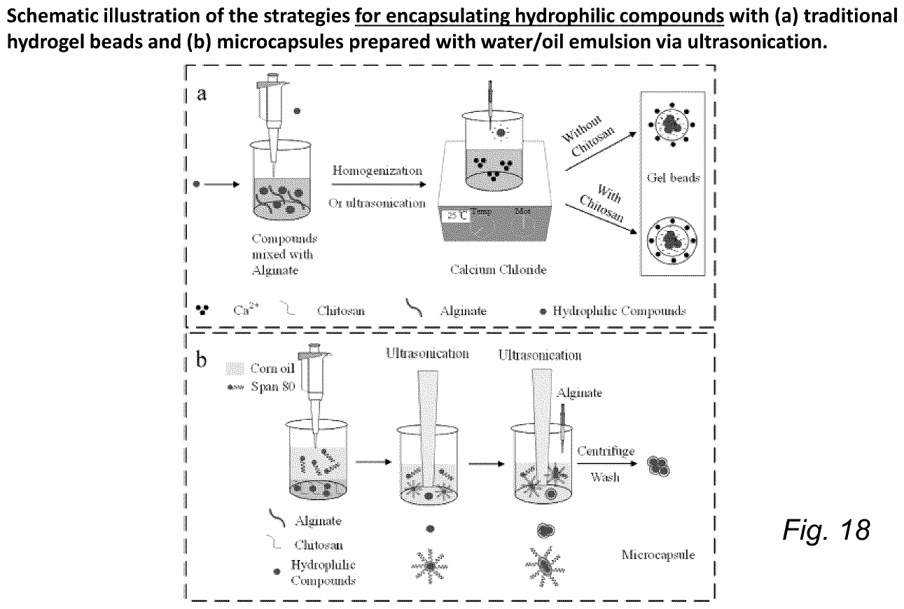

FIG. 18 is a schematic illustration of strategies for encapsulating hydrophilic compounds with (a) traditional hydrogel beads and (b) microcapsules prepared with water/oil emulsion via ultrasonication.

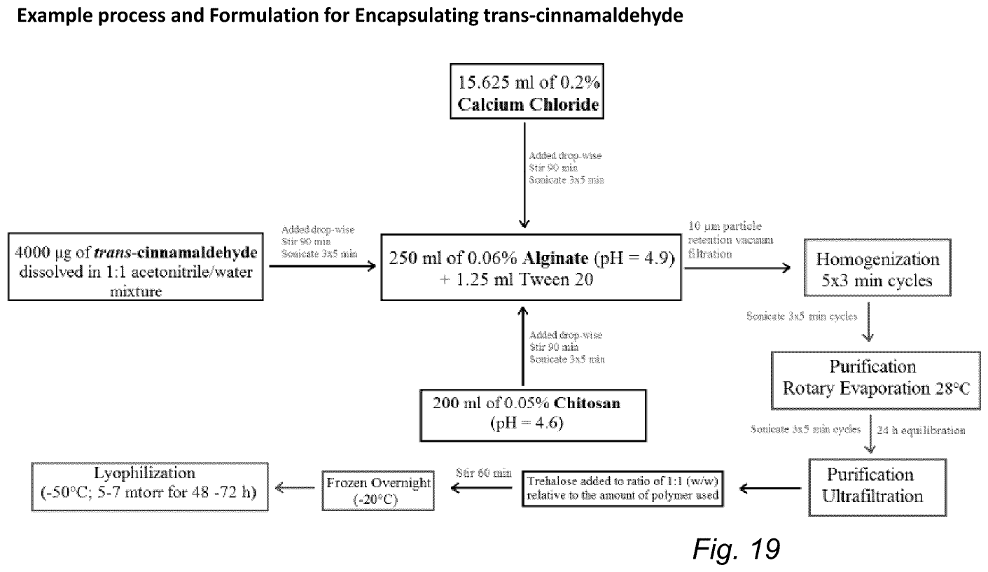

FIG. 19 is a flowchart of a contemplated process and formulation for encapsulating trans-cinnamaldehyde.

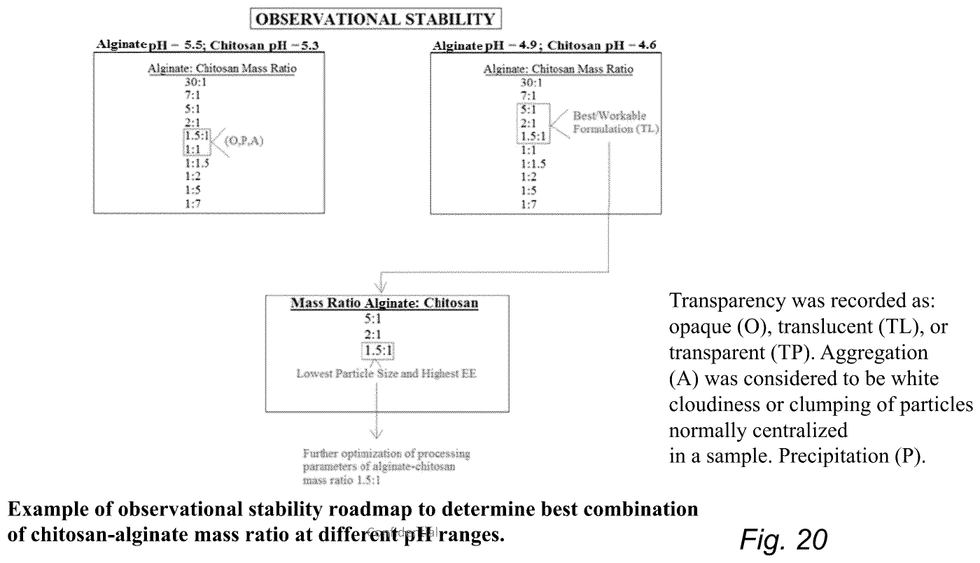

FIG. 20 is a flowchart showing selection of a preferred chitosan-alginate mass ratio.

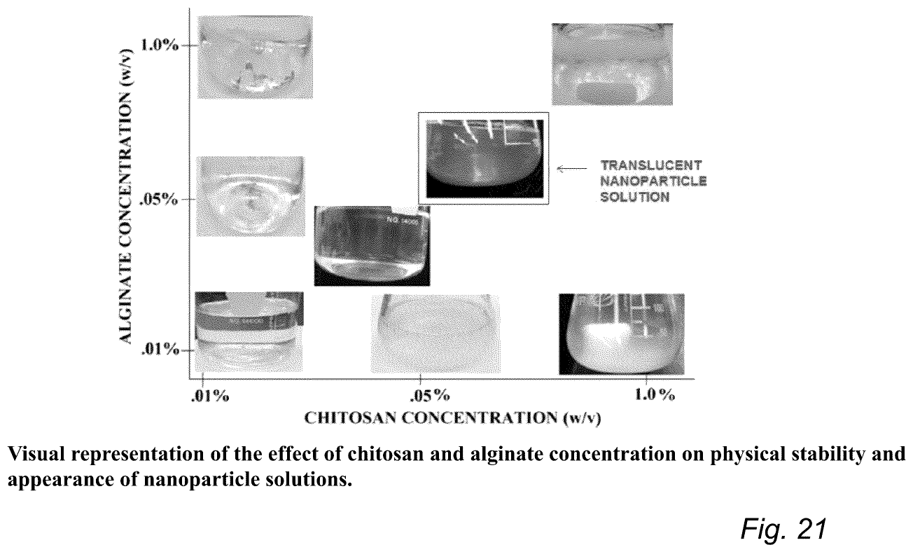

FIG. 21 is a graph with visual representations of effects of chitosan and alginate concentration on physical stability and appearance of nanoparticle solutions.

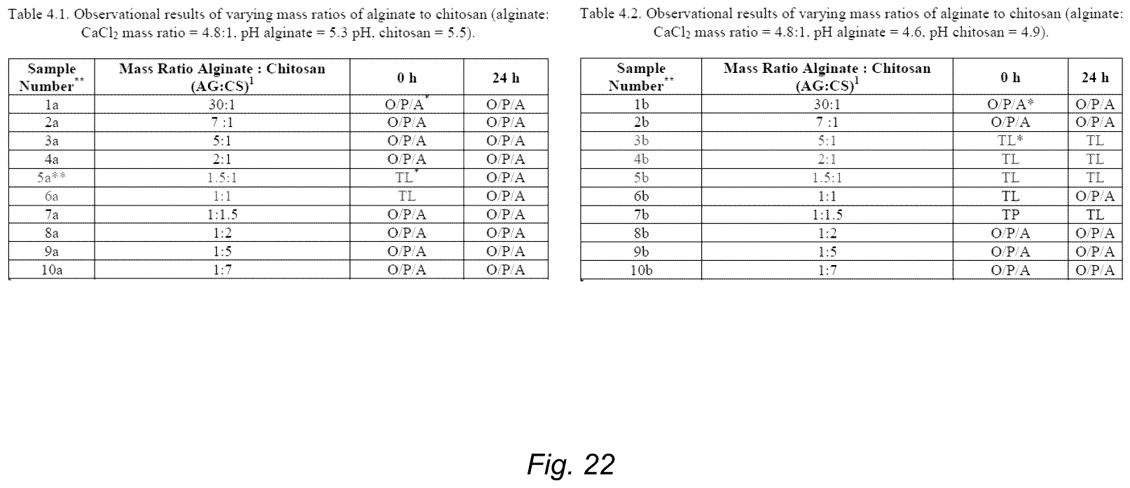

FIG. 22 is a collection of two tables depicting Observational results of varying mass ratios of alginate to chitosan.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C and N, the text should be interpreted as requiring only one element from the group, not A plus N, or B plus N, etc.

What is claimed is:

1. A composition of matter, comprising:
a plant-usable nutrient derived from a first source;
an odiferous compound obtained from a second source different from the first source; and
a water-dissolvable carrier that carries the plant-usable nutrient and the odiferous compound.

2. The composition of claim 1, wherein the first source is selected from the group consisting of an animal excrement, an animal shell, a ground shell of a plant, and seaweed.

3. The composition of claim 2, wherein the animal excrement comprises guano.

4. The composition of claim 2, wherein the animal shell comprises eggshell.

5. The composition of claim 2, wherein the ground shell of a plant comprises coffee grounds.

6. The composition of claim 1, wherein the odiferous compound comprises an essential oil.

7. The composition of claim 6, wherein the essential oil comprises an extract of a culinary herb.

8. The composition of claim 6, wherein the essential oil is selected from the group consisting of thyme, clove, rosemary, lavender, yarrow, basil, and peppermint.

9. The composition of claim 1, wherein the carrier is shaped in the form of a stick.

10. The composition of claim 1, wherein the carrier is shaped in the form of a bead.

11. The composition of claim 1, wherein the carrier is shaped in the form of a tablet.

12. The composition of claim 1, wherein the carrier comprises a water-dissolvable polymer.

13. The composition of claim 12, wherein the water-dissolvable polymer selected from the group consisting of poly (hydroxypropyl methacrylate), poly (l-lysine), poly (aspartic acid), poly (vinylpyrrolidone), poly (N-vinyl-2-pyrrolidone-co-vinylamide), and poly (styrene co-maleic acid/anhydride).

14. The composition of claim 1, wherein the carrier comprises hydrolyzed collagen.

15. The composition of claim 1, wherein the carrier comprises dissolvable seaweed powder.

16. The composition of claim 1, wherein the carrier comprises a compressed multi-component powder.
